(19) United States
(12) Patent Application Publication
(10) Pub. No.: US 2013/0241799 A1
(43) Pub. Date: Sep. 19, 2013

(54) WIRELESS COMMUNICATION DEVICE

(71) Applicant: CARDO SYSTEMS, INC., Pittsburgh, PA (US)

(72) Inventor: Yossef Twina, Rosh-Ha'ayin (IL)

(73) Assignee: Cardo Systems, Inc., Pittsburgh, PA (US)

(21) Appl. No.: 13/887,433

(22) Filed: May 6, 2013

Related U.S. Application Data
(63) Continuation of application No. 29/382,497, filed on Jan. 4, 2011, now Pat. No. D681610.

(51) Int. Cl. H01Q 1/12

(52) U.S. Cl. CPC H01Q 1/125
USPC 343/882

(57) ABSTRACT

A wireless communication device includes a support and a wireless communication device housing which is seatable in the support. The wireless communication device housing defines a channel in at least a portion thereof and which has a first pivot hole extending through a wall of the channel. An antenna has a first end and extends to a second, free end. The first end defines a pivot. The antenna is disposed in the channel so that the pivot is aligned with the first pivot hole. A pivot pin extends through the first pivot hole at the pivot.

This patent application claims the benefit of priority under 35 U.S.C. Section 120 from U.S. patent application Ser. No. 29/382,497, filed on Jan. 4, 2011, now U.S. Patent No. D681,601, which issued on May 7, 2013, which is hereby incorporated by reference as if set forth in its entirety herein.

### FIELD OF THE INVENTION

The present invention concerns wireless communication devices, and more particularly, wireless communication device housings and arrangements.

### SUMMARY OF THE INVENTION

As illustrated and described herein, a wireless communication device includes a support and a wireless communication device housing which is seatable in the support. The wireless communication device housing defines a channel in at least a portion thereof and which has a first pivot hole extending through a wall of the channel. An antenna has a first end and extends to a second, free end. The first end defines a pivot. The antenna is disposed in the channel so that the pivot is aligned with the first pivot hole. A pivot pin extends through the first pivot hole at the pivot.

In accordance with the illustrations and description herein, the first end of the antenna is pivotally mounted about the pivot pin and is movable from a first position (as shown) in which the free end of the antenna is proximate to the housing to a second position different than the first. The first position of the antenna has the antenna extending in a generally parallel direction to one surface of the housing. Operation of the pivot can be appreciated as causing the free end of the antenna to be moved away from the housing when in the second position.

In accordance with the illustrations and description herein, a stop impedes movement of the antenna beyond the second position.

In accordance with the illustrations and description herein, a spring can be disposed within the channel to contact the first end of the antenna, as an additional part that a person having ordinary skill can include.

In accordance with the illustrations and description herein, the housing supports a plurality of controls.

In accordance with the illustrations and description herein, a microphone is disposed at a free end of a boom which extends from the wireless support. Meanwhile, the wireless communication device housing is separate from the support and is removably seatable within the support, and separable from the microphone and its supporting boom. The wireless communication device housing includes contacts that engage mating contacts in the support when seated thereupon.

### BRIEF DESCRIPTION OF THE DRAWING FIGURES

FIG. 1 is a perspective view of a an embodiment of a wireless communication device according to the invention.

FIG. 2 is a front side view of the embodiment of FIG. 1;

FIG. 3 is a rear side view of the embodiment of FIG. 1;

FIG. 4 is a left side view of the embodiment of FIG. 1;

FIG. 5 is a right side view of the embodiment of FIG. 1;

FIG. 6 is a top plan view of the embodiment of FIG. 1; and

FIG. 7 is a bottom plan view of the embodiment of FIG. 1.

### DETAILED DESCRIPTION OF CERTAIN EMBODIMENTS OF THE INVENTION

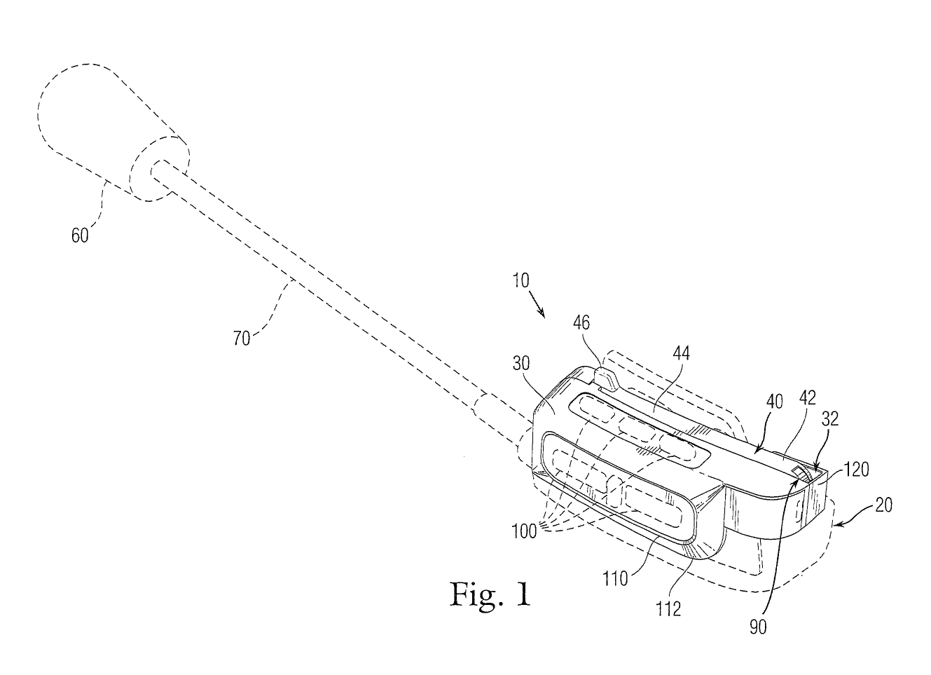

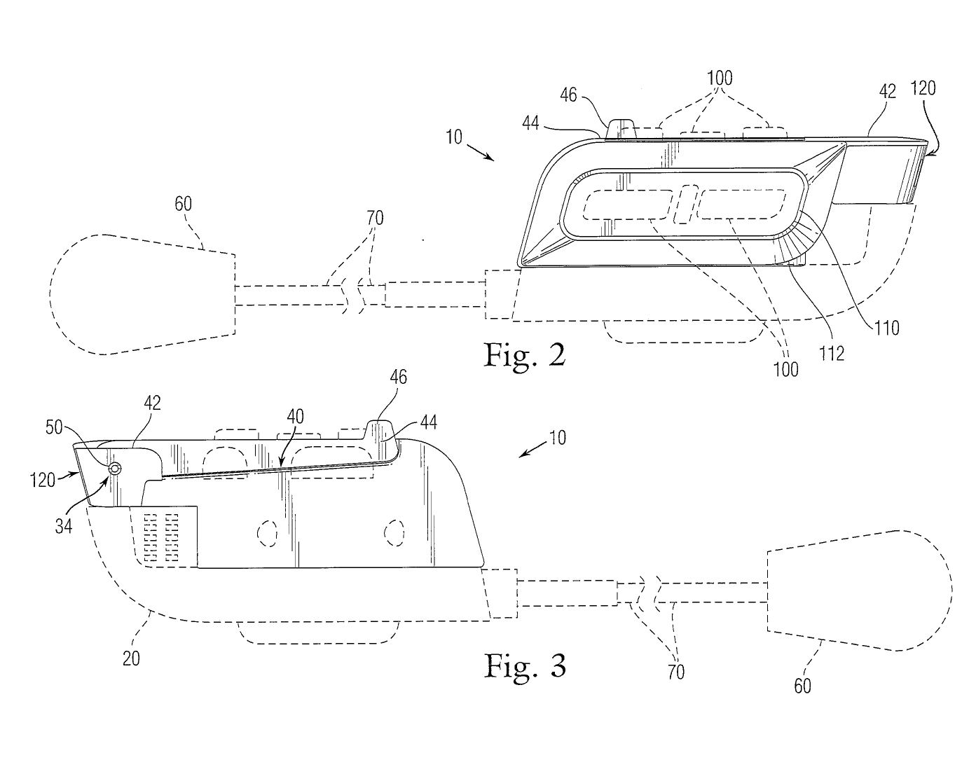

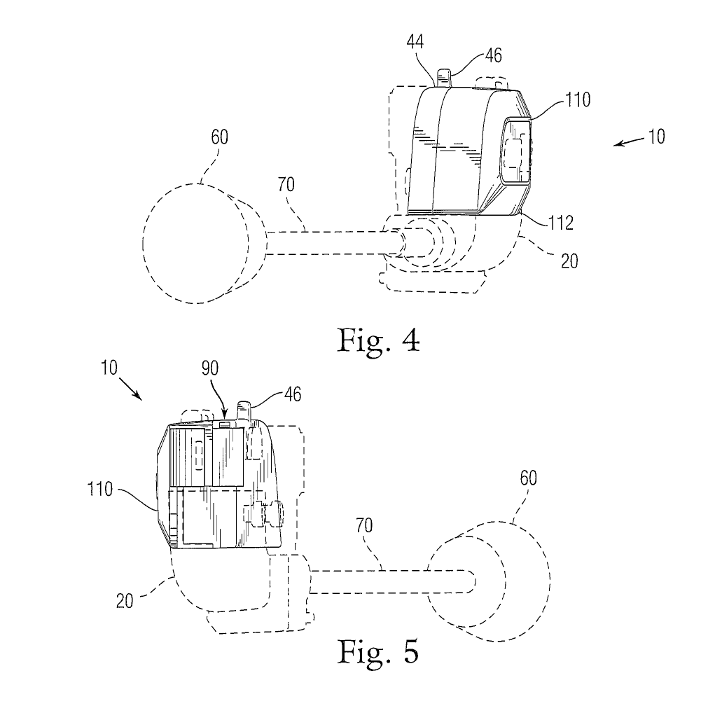

As illustrated, a wireless communication device is seatable in a support 20 and comprises housing 10 that defines a channel 32 in at least a portion thereof. A first pivot hole 34 extends through a wall of the channel 32. An antenna 40 has a first end 42 and extends to a second, free end 44. The first end defines a pivot 46. The antenna is disposed in the channel 32 so that the pivot 46 is aligned with the first pivot hole 34. A pivot pin 50 extends through the first pivot hole at the pivot. See FIGS. 1 and 3.

The first end of the antenna 40 is pivotally mounted about the pivot pin 50 and is movable from a first position (as shown) in which the free end 44 of the antenna is proximate to the housing 10 to a second position different than the first. The first position of the antenna 40 has the antenna extending in a generally parallel direction to one surface of the housing 10. Operation of the pivot can be appreciated as causing the free end of the antenna to be moved away from the housing 10 when in the second position. See FIGS. 1 and 3.

The antenna 40 comprises a solid structure extending from the first end to the free end. As such, the antenna construction is non-telescoping. The antenna 40 defines a generally straight line from the first end 42 to the free end 44, the antenna further comprising a protrusion 46, proximate the free end of the antenna, which extends normal to the generally straight line. In the illustrated embodiment, the solid structure tapers in at least one dimension from the first end 42 toward the free end 44. See FIGS. 1 and 3.

A stop 120 defined by a back wall of the channel 32 of the housing 10 is positioned to impede movement of the antenna 40 beyond the second position.

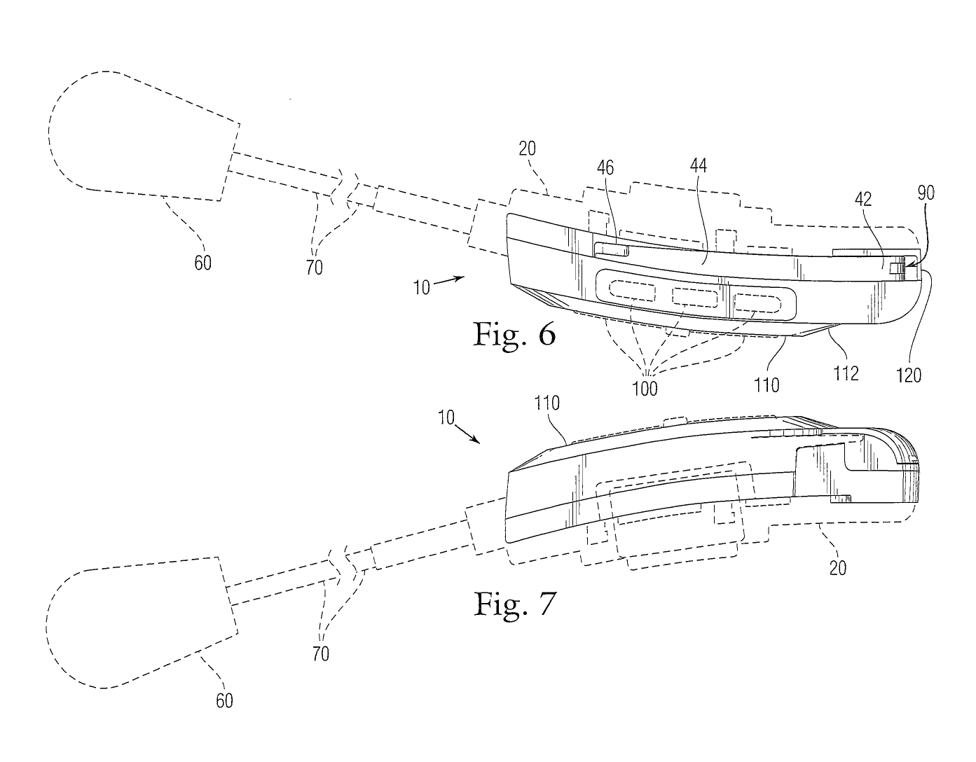

In the illustrated embodiment, a spring 90 is disposed within the channel 32 and in contact with the first end of the antenna. See FIGS. 1, 5 and 6.

In the illustrated embodiment, the housing 10 supports a plurality of controls 100. Also, a bezel 110 having a contoured edge 112 defines a perimeter around at least a portion of the controls 100.

A microphone 60 is disposed at a free end of a boom 70 which extends from the wireless support 20. Meanwhile, the wireless communication device housing, illustrated as the component in solid line, is separate from the support illustrated in broken line, and is removably seatable within the support, and separable from the microphone and its supporting boom. The wireless communication device housing includes contacts that engage mating contacts in the support when seated thereupon. See FIG. 1 and FIG. 3.

My design is not limited to the exact details shown in the drawings, since equivalents and colorable imitations thereof will be evident to a person of ordinary skill in the art. Within the scope, my invention may be practiced otherwise than as specifically shown and described herein.

What is claimed is:

1. A wireless communication device, comprising:
a support;
a communication device having a housing that defines a channel in at least a portion thereof and having a first pivot hole extending through a wall of the channel;
an antenna having a first end and extending to a free end, the first end defining a pivot,
wherein the antenna is disposed in the channel so that the pivot is aligned with the first pivot hole; and
a pivot pin extending through the first pivot hole at the pivot,
wherein the communication device is seatable in the support.

2. The wireless communication device of claim 1, wherein the first end of the antenna is pivotally mounted about the pivot pin and is movable from a first position in which the free end of the antenna is proximate to the communication device to a second position different than the first.

3. The wireless communication device of claim 1, wherein the first position of the antenna has the antenna extending in a generally parallel direction to one surface of the housing of the communication device.

4. The wireless communication device of claim 1, wherein the second position has the free end of the antenna moved away from the communication device.

5. The wireless communication device of claim 1, wherein the antenna comprises a solid structure extending from the first end to the free end.

6. The wireless communication device of claim 1, wherein the solid structure is non-telescoping.

7. The wireless communication device of claim 1, wherein the solid structure tapers in at least one dimension from the first end toward the free end.

8. The wireless communication device of claim 1, further comprising a spring disposed within the channel and in contact with the first end of the antenna.

9. The wireless communication device of claim 1, wherein the housing supports a plurality of controls.

10. The wireless communication device of claim 1, wherein the housing supports a plurality of controls and a bezel having a contoured edge, wherein at least a portion of the controls are disposed within a perimeter of the bezel.

11. The wireless communication device of claim 1, further comprising a boom extending away from the support, the boom supporting a microphone.

12. The wireless communication device of claim 1, wherein the communication device is removably seatable within the support.

13. The wireless communication device of claim 1, wherein the antenna defines a generally straight line from the first end to the free end, the antenna further comprising a protrusion, proximate the free end of the antenna, which extends normal to the generally straight line.

14. The wireless communication device of claim 1, further comprising a stop positioned to impede movement of the antenna beyond the second position.
